(19) United States
(12) Patent Application Publication
(10) Pub. No.: US 2010/0112244 A1
(43) Pub. Date: May 6, 2010

(54) Printed Emblems

(75) Inventor: Randy Carr, Hollywood, FL (US)

Correspondence Address: K&L Gates LLP, STATE STREET FINANCIAL CENTER, One Lincoln Street, BOSTON, MA, 02111-2950, US

(73) Assignee: World Emblem International, Inc., Miami, FL (US)

(21) Appl. No.: 12/261,682

(22) Filed: Oct. 30, 2008

(51) Int. Cl. B32B 38/14

(52) U.S. Cl. 428/32.18; 156/277

(57) ABSTRACT

The invention provides a multilayer emblem, which includes a fabric layer, a thermoplastic adhesive layer, and an ink layer. Also provided is a method of manufacturing an emblem, which includes the steps of disposing a thermoplastic adhesive layer on a first side of a fabric layer and disposing an ink layer on a second side of the fabric layer. Further provided is a method of printing an emblem, which includes the steps of disposing a thermoplastic adhesive layer on a first side of a fabric layer, disposing an ink layer on a second side of the fabric layer, and printing a first design on the ink layer.

### FIELD

The present invention relates to the field of emblems and emblem production.

### SUMMARY

In one aspect, the invention provides a method of manufacturing an emblem. The method includes the steps of providing a fabric layer having first and second surfaces, disposing a thermoplastic adhesive layer on the first surface of the fabric layer, and disposing an ink layer on the second surface of the fabric layer. In some embodiments, the ink layer may include a nylon ink. In some embodiments, the fabric layer may be a polyester fabric, such as a 2 oz. polyester fabric. In some embodiments, the thermoplastic adhesive layer may be a polyurethane, such as a 3 mil clear polyurethane. In various embodiments, the thermoplastic adhesive may be disposed on the first surface of the fabric layer by heat sealing. In various embodiments, the ink may be disposed on the second surface of the fabric layer by screen printing.

In some embodiments, the method may include the step of printing a design on the ink layer. The design may be printed on the ink layer using, for example, a screen printer, an inkjet printer, a digital printer, a laser printer, a ribbon printer, and combinations thereof. The design may be printed using, for example, ultraviolet ink, inkjet ink, laser ink, ribbon ink, and combinations thereof.

In another aspect, the invention provides a method of printing an emblem. The method includes the steps of providing a fabric layer having first and second surfaces, disposing a thermoplastic adhesive layer on the first surface of the fabric layer, disposing an ink layer on the second surface of the fabric layer, and printing a first design on the ink layer. In some embodiments, the ink layer may include a nylon ink. The design may be printed on the ink layer using, for example, a screen printer, an inkjet printer, a digital printer, a laser printer, a ribbon printer, and combinations thereof. The design may be printed using, for example, ultraviolet ink, inkjet ink, laser ink, ribbon ink, and combinations thereof. In some embodiments, the method may include the step of embroidering a second design over the first design.

In another aspect, the invention provides a multilayer emblem that includes a fabric layer having a first surface and a second surface, a thermoplastic adhesive layer, and an ink layer. The thermoplastic adhesive layer is disposed on the first surface of the fabric layer, and the ink layer is disposed on the second surface of the fabric layer. In some embodiments, the fabric layer may be a polyester fabric, such as a 2 oz. polyester fabric. In some embodiments, the thermoplastic adhesive layer may be a polyurethane, such as a 3 mil clear polyurethane. In some embodiments, the ink layer may include a nylon ink. In some embodiments, the ink may be white.

### BRIEF DESCRIPTION OF DRAWINGS

The foregoing and other objects, aspects, features, and advantages of the invention will become more apparent and may be better understood by referring to the following description taken in conjunction with the accompanying drawings, in which:

FIG. 1 depicts a cross sectional view of an exemplary emblem in accordance with an illustrative embodiment of the invention.

### DETAILED DESCRIPTION

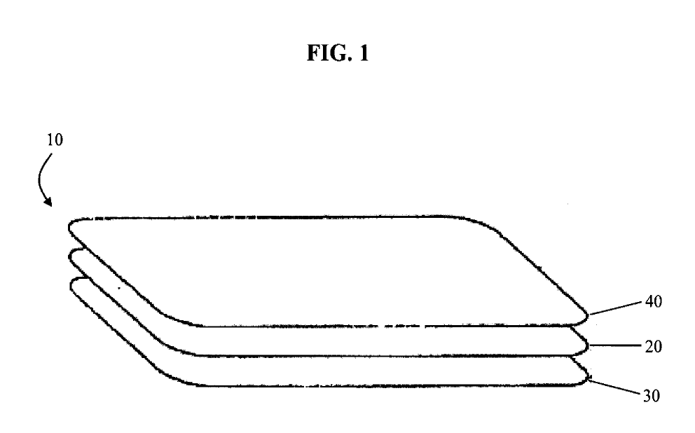

Referring to FIG. 1, in one embodiment, an emblem 10 includes three layers, namely a fabric layer 20, a thermoplastic adhesive layer 30, and an ink layer 40. The fabric layer 20 has at least a first surface and a second surface (i.e., a first side and a second side). The fabric layer 20 provides a support surface for the thermoplastic adhesive layer 30 and the ink layer 40 and also provides body to the emblem 10. The fabric layer 20 can be any suitable thickness, such as, for example, about 1 oz., about 2 oz., about 3 oz., about 4 oz., about 5 oz., about 6 oz., about 7 oz., about 8 oz., about 9 oz., or about 10 oz. In some embodiments, the fabric layer 20 can be a polyester fabric and, preferably, can be a polyester non-woven fabric such as Pelon. In a preferred embodiment, the fabric layer 20 is a 2 oz. polyester fabric.

With continued reference to FIG. 1, a thermoplastic adhesive layer 30 is disposed on a first surface of the fabric layer 20. The thermoplastic adhesive layer 30 can be any suitable adhesive which allows the emblem 10 to be heat sealed onto a substrate, such as a garment or another layer of material. In some embodiments, the thermoplastic adhesive layer 30 includes a urethane, such as a polyurethane. The thermoplastic adhesive layer 30 can be any suitable thickness, such as, for example, about 1 mil, about 2 mil, about 3 mil, about 4 mil, about 5 mil, about 6 mil, about 7 mil, about 8 mil, about 9 mil, or about 10 mil. In a preferred embodiment, the thermoplastic adhesive layer is a 3 mil clear polyurethane. The thermoplastic adhesive layer 30 can be disposed over substantially the entire first surface of the fabric layer 20, or the thermoplastic adhesive layer 30 can be disposed over a portion of the first surface of the fabric layer 20.

The fabric layer 20 and the thermoplastic adhesive layer 30 may be bonded together by heat sealing, preferably at a temperature of about 350 to 450 degrees Fahrenheit (° F.), and more preferably at about 400° F. In an embodiment, the heating is performed under conditions of about 20 to about 70 pounds per square inch (“psi”) of pressure, preferably about 60 psi, for about from 4 to 18 seconds.

With continued reference to FIG. 1, an ink layer 40 is disposed on a second surface of the fabric layer 20. In some embodiments, the ink layer 40 provides a background onto which one or more designs can be printed and/or embroidered. As used herein, the term “design” includes any marking, such as, for example, one or more letters, words, logos, drawings, pictures, insignias, trademarks, and combinations thereof. The ink can be any suitable color. In a preferred embodiment, the ink is white. In some embodiments, the ink is a nylon ink or includes a nylon ink. The ink layer 40 can be deposited on the second surface of the fabric layer 20 using screen printing or any other suitable method. The ink layer 40 can be disposed over substantially the entire second surface of the fabric layer 20, or the ink layer 40 can be disposed over a portion of the second surface of the fabric layer 20.

One or more designs can be printed on the ink layer 40. Any suitable printing method can be used to print a design on the ink layer 40. For example, a design can be printed on the ink layer 40 using screen printing, digital printing, inkjet printing, and combinations thereof. In addition, any suitable ink can be used to print the design on the ink layer 40, such as for example, ultraviolet ink, inkjet ink, laser ink, ribbon ink, and combinations thereof. In some embodiments, a second design is embroidered over a first printed design.

The emblem 10 as described herein may be used in a variety of different manners. In some embodiments, the emblem 10 may be used in connection with embroidered emblems. In some embodiments, the emblem 1O may be used in connection with screen printing of emblems. In still other embodiments, the emblem 10 may be used in connection with sublimation processes used to construct emblems.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A method of manufacturing an emblem, the method comprising the steps of:
providing a fabric layer having a first surface and a second surface;
disposing a thermoplastic adhesive layer on the first surface of the fabric layer; and
disposing an ink layer on the second surface of the fabric layer.

2. The method of claim 1, wherein the ink layer comprises a nylon ink.

3. The method of claim 1, wherein the fabric layer comprises polyester.

4. The method of claim 3, wherein the fabric layer is a 2 oz. polyester fabric.

5. The method of claim 1, wherein thermoplastic adhesive layer comprises a polyurethane.

6. The method of claim 5, wherein the thermoplastic adhesive layer is a 3 mil clear polyurethane.

7. The method of claim 1, wherein the thermoplastic adhesive is disposed on the first surface of the fabric layer by heat sealing.

8. The method of claim 1, wherein the ink is disposed on the second surface of the fabric layer by screen printing.

9. The method of claim 1, further comprising the step of printing a design on the ink layer.

10. The method of claim 9, wherein the design is printed using a printer selected from the group consisting of a screen printer, an inkjet printer, a digital printer, a laser printer, a ribbon printer, and combinations thereof.

11. The method of claim 9, wherein the design is printed using an ink selected from the group consisting of ultraviolet ink, inkjet ink, laser ink, ribbon ink, and combinations thereof.

12. A method of printing an emblem, the method comprising the steps of providing a fabric layer having a first surface and a second surface;
disposing a thermoplastic adhesive layer on the first surface of the fabric layer;
disposing an ink layer on the second surface of the fabric layer; and
printing a first design on the ink layer.

13. The method of claim 12, wherein the ink layer comprises a nylon ink.

14. The method of claim 12, wherein the design is printed using a printer selected from the group consisting of a screen printer, an inkjet printer, a digital printer, a laser printer, a ribbon printer, and combinations thereof.

15. The method of claim 12, wherein the design is printed using an ink selected from the group consisting of ultraviolet ink, inkjet ink, laser ink, ribbon ink, and combinations thereof.

16. The method of claim 12, further comprising the step of embroidering a second design over the first design.

17. An emblem comprising:
a fabric layer having a first surface and a second surface;
a thermoplastic adhesive layer disposed on the first surface of the fabric layer; and
an ink layer disposed on the second surface of the fabric layer.

18. The method of claim 17, wherein the ink layer comprises a nylon ink.

19. The emblem of claim 15, wherein the fabric layer comprises a polyester.

20. The emblem of claim 19, wherein the fabric layer is a 2 oz. polyester fabric.

21. The emblem of claim 17, wherein the thermoplastic adhesive layer comprises a polyurethane.

22. The emblem of claim 21, wherein the thermoplastic adhesive layer is a 3 mil clear polyurethane.

23. The emblem of claim 17, wherein the ink is white.
